(19) United States
(12) Patent Application Publication
(10) Pub. No.: US 2026/0205299 A1
(43) Pub. Date: Jul. 16, 2026

(54) COMPUTER-IMPLEMENTED AUTHORIZATION METHOD AND SYSTEM

(71) Applicant: The Mirror Project LLC, Boca Raton, FL (US)

(72) Inventor: Scott Lipskin, Boca Raton, FL (US)

(73) Assignee: The Mirror Project LLC, Boca Raton, FL (US)

(21) Appl. No.: 19/561,643

(22) Filed: Mar. 10, 2026

Related U.S. Application Data
(63) Continuation of application No. 19/461,799, filed on Jan. 28, 2026.

(51) Int. Cl. H04L 9/32; G06V 40/40

(52) U.S. Cl. CPC H04L 9/3231; G06V 40/40; H04L 9/3247; H04L 9/3271

(57) ABSTRACT

A computer-implemented authorization method is provided. The method includes generating with a cryptographic module a real-time digital authorization artifact based on a live human authorization event, emitting the real-time digital authorization artifact from the cryptographic module, consuming the real-time digital authorization artifact at a requester system as a prerequisite for an action in the requester system in order to prove that a real human being was present and authorized during a set time window on a user device, and providing the requester system as being architecturally separated from the cryptographic module.

### CROSS-REFERENCE TO RELATED APPLICATION

This application is a continuation patent application that claims priority to and claims the benefit of U.S. Patent Application Serial No. 19/461,799, filed January 28, 2026, and entitled “COMPUTER-IMPLEMENTED AUTHORIZATION METHOD AND SYSTEM”, the contents of which are incorporated herein by reference in their entirety.

### BACKGROUND

Passwords and traditional session-based authentication mechanisms are insufficient in modern software environments due to phishing, credential theft, replay attacks, session hijacking, SIM-swap vulnerabilities, and deficiencies in terms of proving human presence. Existing approaches that do not employ passwords (e.g., device unlock states, passkeys, and biometrics) may authenticate an account or device, but suffer from a number of drawbacks. These drawbacks become quite pronounced in emerging agentic artificial intelligence (AI) environments in which actions may be initiated, chained, or delegated by autonomous systems, such that it is often difficult to establish clear human authorization boundaries and attribution.

It is with respect to these and other considerations that the instant disclosure is concerned.

### SUMMARY

In one aspect of the disclosed concept, a computer-implemented authorization method is provided. The method comprises generating with a cryptographic module a real-time digital authorization artifact based on a live human authorization event; emitting the real-time digital authorization artifact from the cryptographic module; consuming the real-time digital authorization artifact at a requester system as a prerequisite for an action in the requester system in order to prove that a real human being was present and authorized during a set time window on a user device; and providing the requester system as being architecturally separated from the cryptographic module.

In another aspect, an authorization system is provided. The authorization system comprises a cryptographic module configured to generate a real-time digital authorization artifact based on a live human authorization event, and emit the real-time digital authorization artifact; and a requester system configured to consume the real-time digital authorization artifact as a prerequisite for an action in order to prove that a real human being was present and authorized during a set time window on a user device, the requester system being architecturally separated from the cryptographic module.

### BRIEF DESCRIPTION OF THE DRAWINGS

FIG. 1 is a schematic of an authorization system, shown as employed with a user device and a backend server, in accordance with one non-limiting embodiment of the disclosed concept.

FIG. 2A is a flow chart corresponding to an enrollment process in connection with the authorization system of FIG. 1.

FIG. 2B is a flow chart corresponding to generation, emission, and consumption of a real-time digital authorization artifact in connection with the authorization system of FIG. 1.

FIG. 3 is a computer-implemented authorization method which may be executed by the authorization system of FIG. 1.

### DETAILED DESCRIPTION

In the following description, for the purposes of explanation, numerous specific details are set forth in order to provide a thorough understanding of various embodiments of the invention. As used herein, “embodiments” are non-limiting examples of apparatuses or methods employing one or more of the inventive concepts disclosed herein. It is apparent, however, that various embodiments may be practiced without these specific details or with one or more equivalent arrangements. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features of the various embodiments may be otherwise combined, separated, interchanged, and/or rearranged without departing from the inventive concepts.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “may include,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, may be used as terms of approximation and not as terms of degree, and, as such, are utilized to account for inherent deviations in measured, calculated, and/or provided values that would be recognized by one of ordinary skill in the art.

As employed herein, the term “number” shall mean one or an integer greater than one (i.e., a plurality).

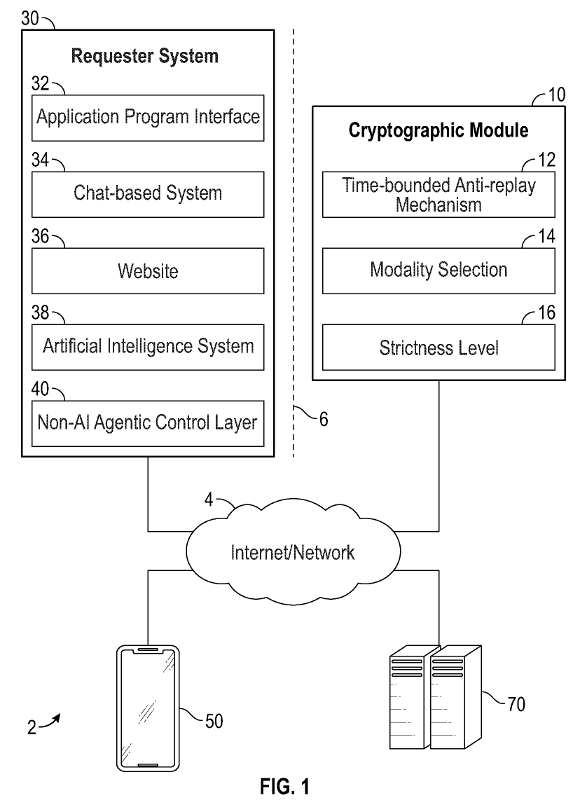

FIG. 1 shows an authorization system 2 as employed with a user device 50 and a backend server 70, in accordance with one non-limiting embodiment of the disclosed concept. In one example, the authorization system 2 may include a cryptographic module 10 (e.g., without limitation, a hardware-backed key store such as a secure enclave, TPM, and TEE) and a requester system 30, each of which may be communicable over an internet/network 4, and each of which may be architecturally separated from one another. In one example, the disclosed authorization system 2 may treat human authorization itself as a distinct, enforceable system layer that produces an artifact for downstream consumption.

More specifically, the cryptographic module 10 may be configured to generate a real-time digital authorization artifact 120 (e.g., without limitation, a cryptographically verifiable authorization artifact) based on a live human authorization event, and emit the real-time digital authorization artifact 120. Furthermore, the requester system 30 may be configured to consume the real-time digital authorization artifact 120 as a prerequisite for an action 46 in order to prove that a real human being 100 was present and authorized during a set time window on the user device 50. The real-time digital authorization artifact 120 may be bound to the user device 50 and be consumable (e.g., without limitation, machine-consumable) by downstream software systems.

In one example, the real-time digital authorization artifact 120 may prove that the real human being 100 was present and authorized at a given time on a specific enrolled device, which may be the user device 50. The authorization system 2 may use live human presence verification with a number of biometric participations, device-owner confirmation, and time-bounded anti-replay mechanisms. Furthermore, the generated real-time digital authorization artifact 120 may be consumed by the external requester system 30 as a prerequisite for the action 46, and such that the authorization system 2 may not make decisions, interpret intent, or execute actions, but have as one example purpose the establishment of real-time human authorization and emission of a verifiable authorization event.

For example, the authorization system 2 may be configured to verify both that the real human being 100 is physically present and interacting in real time, and that the correct authorized human associated with the bound device (e.g., the user device 50) and authorization context is the one providing consent. The authorization system 2 may explicitly distinguish between mere human presence and correct human authorization. Authorization signals may not be satisfied by the presence of an arbitrary, substitute, or coerced individual, even if that individual is human.

The authorization system 2 may thus answer the question of whether a real human being, and the correct intended human being, was physically present with the bound device and explicitly authorizing an action at a specific moment in time. The determination of the correct authorized human may not rely on persistent identity sessions, password-based authentication, or long-term biometric storage. Instead, correct-human authorization may be enforced through a combination of a prior device-to-human association, an explicit user consent to participate in authorization signaling, a live, real-time authorization interaction, a device-bound authorization capture, and a rejection of authorization attempts originating from non-bound or remote devices.

Accordingly, the authorization system 2 may generate authorization only when the bound user device 50 confirms that the participating real human being 100 corresponds to the intended authorization context at the moment of request. Existing authentication or liveness-detection systems (not shown), by way of contrast, may verify that a human is present or that credentials are valid, but may not enforce that the intended human associated with a specific authorization context is the one providing consent at the moment of action. The disclosed authorization system 2 may thus introduce a real-time authorization boundary that verifies correct human presence, not generic human interaction or account access. Furthermore, the verification in the authorization system 2 may be performed solely for real-time authorization and may not constitute identity authentication, identity storage, or permission evaluation. That is, the authorization system 2 may produce a time-limited authorization event rather than a persistent identity assertion.

As will be discussed, the real-time digital authorization artifact 120 may be, for example and without limitation, a discrete, time-bound, non-replayable artifact proving that a live human was present and explicitly authorized at a specific moment on a specific device, such as the user device 50. Usage of the real-time digital authorization artifact 120 may advantageously allow for authentication and authorization, access control, identity assurance, and control-plane enforcement in software-mediated environments including messaging and chat, web services, mobile applications, and AI/agentic systems. More specifically, the disclosed authorization system 2 may not employ passwords, authorization inferred from login information, or session-based authentication mechanisms in order to avoid phishing, credential theft, replay attacks, session hijacking, and SIM-swap vulnerabilities, and may do so while proving real-time human presence.

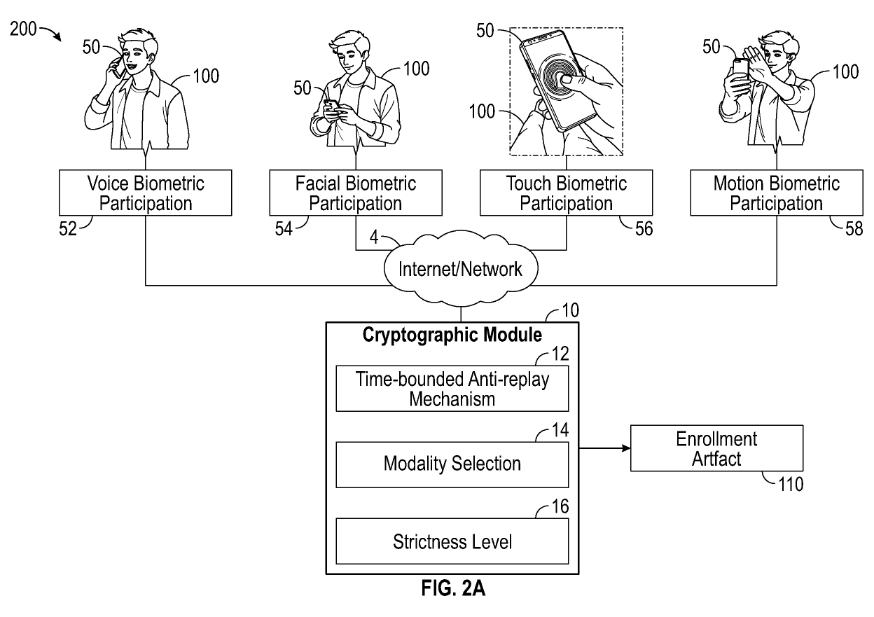

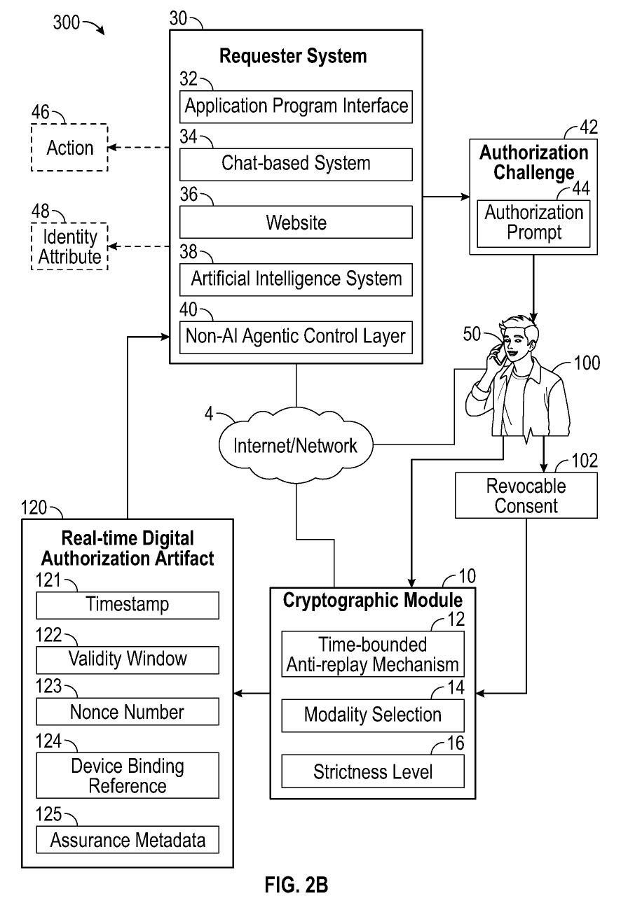

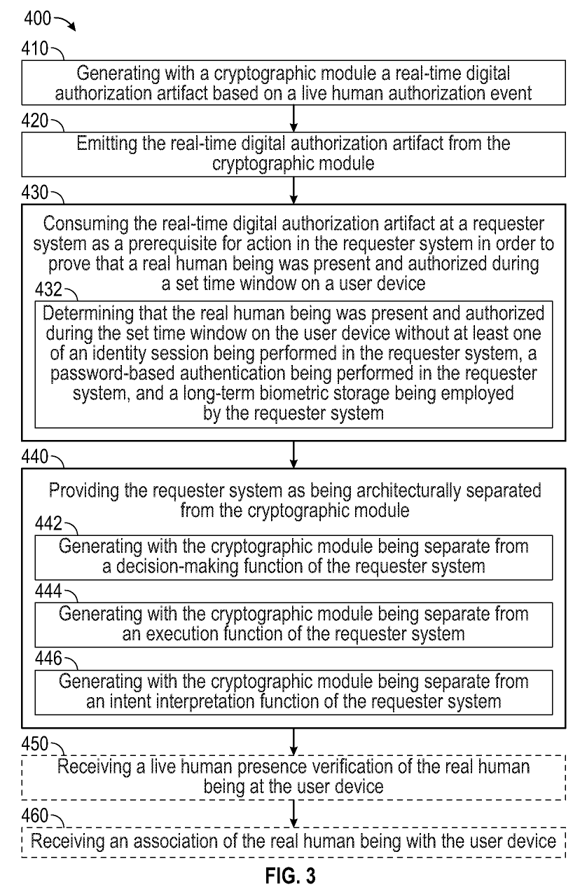

FIG. 2A is a flow chart 200 corresponding to an enrollment process in connection with the authorization system 2 of FIG. 1. FIG. 2B is a flow chart 300 corresponding to generation, emission, and consumption of the real-time digital authorization artifact 120 in connection with the authorization system 2 of FIG. 1. FIG. 3 is a computer-implemented authorization method 400 which may be executed by the authorization system 2 of FIG. 1.

As shown in FIG. 3, the method 400 may include a first step 410 of generating with a cryptographic module 10 a real-time digital authorization artifact 120 based on a live human authorization event, a second step 420 of emitting the real-time digital authorization artifact 120 from the cryptographic module 10, a third step 430 of consuming the real-time digital authorization artifact 120 at a requester system 30 as a prerequisite for the action 46 in the requester system 30 in order to prove that a real human being 100 was present and authorized during a set time window on a user device 50, and a fourth step 440 of providing the requester system 30 as being architecturally separated from the cryptographic module 10. These steps will be more apparent in connection with discussion of FIGS. 2A and 2B.

Referring again to FIG. 2A, during enrollment, the disclosed authorization method 400 further includes a step of generating with the cryptographic module 10 an enrollment artifact 110 before generating with the cryptographic module 10 the real-time digital authorization artifact 120 (FIG. 2B). The enrollment artifact 110 may subsequently serve as reference material, while the real-time digital authorization artifact 120 may be generated per live authorization event.

During such enrollment, the cryptographic module 10 may receive from the user device 50 via the internet/network 4 a number of biometric participations 52,54,56,58 of a real human being 100. The biometric participations 52,54,56,58 may include any one or combination of a voice biometric participation 52, a facial biometric participation 54, a touch biometric participation 56, and a motion biometric participation 58. In response to receiving the biometric participations 52,54,56,58, the cryptographic module 10 may generate the enrollment artifact 110, which may be a digital enrollment artifact 110, and which may later serve as a basis for comparison with the real-time digital authorization artifact 120 (FIG. 2B) in order to prove that the real human being 100 was present and authorized during a set time window on the user device 50. During enrollment, the biometric participations 52,54,56,58 may be signals that are used as comparison material and may not be constituted as authorization or reusable credentials. Enrollment in accordance with the disclosed concept thus may refer to the initial binding of the real human being to the specific user device 50 and the cryptographic module 10, including collection of reference signals used for later comparison, optionally only for later comparison. The requester system 30 may also not be involved in enrollment beyond relying on the resulting enrollment artifact 110 during runtime. More specifically, the requester system 30 may not independently authenticate or authorize the action, but instead may be gated on receiving the real-time digital authorization artifact 120 in response to a live human authorization event on the enrolled user device 50.

Accordingly, the real human being 100 may enroll by, for example and without limitation, enrolling a biometric participation (e.g., without limitation, voice) for live presence verification, optionally enabling additional biometrics via OS frameworks, optionally consenting to disclosure of limited identity attributes (e.g., name, age), and defining standing consent and revocation rules. As will be discussed, a requester may then issue an authorization challenge 42 with nonce, scope, and expiry. The authorization challenge 42 may then be delivered to the user device 50, which may be an enrolled device. Additionally, the user may complete a verification (e.g., live voice verification) and the user device 50 may confirm enrolled owner state and unlock a signing key. Thus, the real-time digital authorization artifact 120 may be based on a live human authorization event and constructed with a timestamp 121, a validity window 122, a nonce number 123, a device binding reference 124, and assurance metadata 125. The real-time digital authorization artifact 120 may also be cryptographically signed and returned to the requester system 30, such that the requester system 30 may verify at least one of freshness, signature, and scope before proceeding.

Referring again to FIG. 2B, during generation, emission, and consumption of the real-time digital authorization artifact 120, the user device 50 may receive the authorization challenge 42 from the requester system 30 before the cryptographic module 10 generates the real-time digital authorization artifact 120. Furthermore, the user device 50 may be configured to control the cryptographic module 10 to generate and emit the real-time digital authorization artifact 120. As shown, the requester system 30 may include any one or combination of an application program interface 32, a chat-based system 34, a website 36, an AI system 38, and a non-AI agentic control layer 40, each of which may be provided with authorization benefits afforded by connection to the cryptographic module 10. In one example, the authorization challenge 42 may include a real-time, dynamically generated authorization prompt 44 to which the real human being 100 may respond within a constrained time window.

More specifically, the method 400 may further include steps of initiating the authorization prompt 44 at the requester system 30, receiving at the user device 50 the authorization prompt 44, which may be configured to require an immediate response from the real human being 100 within a constrained time window, and receiving at the user device 50 the immediate response from the real human being 100 within the constrained time window in response to receiving at the user device 50 the real-time, dynamically generated authorization prompt 44. In one example, the authorization challenge 42 and the authorization prompt 44 may be initiated at the requester system 30, but the authorization prompt 44 may be generated and enforced by the cryptographic module 10, not the requester system 30. That is, in one example substantially all or all security-critical authorization function within the authorization system 2 may reside within the cryptographic module 10. Additionally, in response to receiving the immediate response from the real human being 100, the cryptographic module 10 may generate the real-time digital authorization artifact 120, which may then be consumed by the requester system 30 as a prerequisite for the action 46 in order to prove that the real human being 100 was present and authorized during a set time window on the user device 50.

Accordingly, the authorization prompt 44 may be considered to be modality-agnostic, allowing responses via voice, facial interaction, fingerprint or touch-based interaction, motion, or combinations thereof. An example security property of the authorization system 2 may thus derive from real-time prompting and device possession rather than reliance on any single biometric. Furthermore, it will also be appreciated that behavior of the authorization prompt 44, timing windows, response modalities, and acceptance thresholds may be independently configurable, allowing enforcement behavior to be precisely tuned through parameters for different risk profiles, environments, or deployment contexts without modifying a core logic of the requester system 30.

By consuming the real-time digital authorization artifact 120 as a prerequisite for the action 46, the requester system 30 may advantageously be provided with a number of advantages over known authorization systems (not shown), including that authorization may be performed without an identity session, a password-based authentication, and a long-term biometric storage being employed. The authorization system 2 may thus advantageously avoid password-centric or static credential storage approaches. As a result, and with reference again to FIG. 3, the step 430 may further include a step 432 of determining that the real human being 100 was present and authorized during the set time window on the user device 50 without at least one of an identity session being performed in the requester system 30, a password-based authentication being performed in the requester system 30, and a long-term biometric storage being employed by the requester system 30. Furthermore, generation of the real-time digital authorization artifact 120 with the cryptographic module 10 may be performed without inference from stored enrollment data.

In one example, the authorization prompt 44 may be a system-initiated, unpredictable, and/or non-reusable prompt in order to provide an enforcement mechanism for liveness and replay resistance with respect to generation of the real-time digital authorization artifact 120. The authorization prompt 44 may also be a modality-agnostic prompt in order to allow the immediate response to be provided from at least one of a voice, facial, touch, and motion biometric participation of the real human being 100. Initiating the authorization prompt 44 and receiving at the user device 50 the immediate response may each also be performed in an independently configurable manner in order to allow the real-time digital authorization artifact 120 to be tuned via a number of parameters for at least one of a number of different risk profiles, a number of different environments, and a number of different deployment contexts.

Accordingly, the requester system 30 may send the authorization challenge 42 to the user device 50 of the real human being 100, and the real human being 100 may provide an immediate response, which may include a live human authorization event. For example and without limitation, the user device 50 may receive a live human presence verification of the real human being 100, and the cryptographic module 10 may be configured to receive an association of the real human being 100 with the user device 50. In one example, the live human authorization event may include both the live presence verification and the association of the real human being 100 with the user device 50. Thus, the method 400 may also include a step 450 of receiving a live human presence verification of the real human being 100 at the user device 50, and a step 460 of receiving an association of the real human being 100 with the user device 50.

It will also be appreciated that initiating the authorization prompt 44 and receiving at the user device 50 the immediate response may each be performed without modifying a core logic of the requester system 30. In this manner, and with reference again to FIG. 1, the cryptographic module 10 and the requester system 30 are shown with an architectural separation boundary 6 therebetween in order to reinforce that authorization control in the authorization system 2 may reside entirely within the cryptographic module 10 and not the requester system 30. This is to denote that the cryptographic module 10 may advantageously be architecturally separated from the requester system 30, for example, separate from a decision-making function, execution function, and/or intent interpretation function of the requester system 30. As such, the step 440 in FIG. 3 may further include a step 442 of generating with the cryptographic module 10 separate from a decision-making function of the requester system 30, a step 444 of generating with the cryptographic module 10 separate from an execution function of the requester system 30, and/or a step 446 of generating with the cryptographic module 10 separate from an intent interpretation function of the requester system 30.

Additionally, the cryptographic module 10 may have a modality selection 14 and a strictness level 16. In accordance with the disclosed concept, generating with the cryptographic module 10 the real-time digital authorization artifact 120 may be performed with the modality selection 14 and the strictness level 16 each being policy-configurable and not architecturally fixed with respect to the cryptographic module 10.

In one example, the live human presence verification provided by the real human being 100 during the human authorization event may include a voice biometric participation of the real human being 100, as well as other biometric participations (e.g., without limitation, facial, touch, motion), and these biometric participations may later be compared to the biometric participations 52,64,56,58 provided by the real human being 100 during enrollment.

More specifically, after the cryptographic module 10 generates the real-time digital authorization artifact 120, the requester system 30, from which the authorization challenge 42 originated, may then consume the real-time digital authorization artifact 120. In this regard, the real-time digital authorization artifact 120 may be provided as a runtime artifact, and the runtime artifact may be separate from the enrollment artifact 110, with multiple permissible modalities being configured for runtime authorization (e.g., any combination of voice, facial, touch, motion, or other real-time human signals).

The method 400 may also further include a step of comparing with the requester system 30 the runtime artifact (e.g., the real-time digital authorization artifact 120) to the enrollment artifact 110 in order to prove that the real human being 100 was present and authorized during the set time window on the user device 50. In other words, after the real-time digital authorization artifact 120 is generated, the requester 30 may consume it in order to perform its authorization.

This may include relying on certain aspects of the real-time digital authorization artifact 120 in order to perform the authorization. For instance, the real-time digital authorization artifact 120 may include at least one of a timestamp 121, a validity window 122, a nonce number 123, a device binding reference 124, and assurance metadata 125. These aspects may allow the requester system 30 to verify at least one of a freshness, a signature, and a scope of the real-time digital authorization artifact 120 after consumption at the requester system 30.

As stated above, the requester system 30 may include the AI system 38, which may be any AI system, including an AI agentic system. In this instance, the action 46 may include an invocation of the AI system 38. As such, the method 400 of FIG. 3 may further include at least one of permitting, deferring, and blocking the invocation based on a signal corresponding to at least one of a presence of the live human authorization event, a provenance indicator of the real-time digital authorization artifact 120, a source-of-origin indicator of the real-time digital authorization artifact 120, and/or a scope and/or authority mismatch relative to a context of the invocation. Thus, the requester system 30 may consume the real-time digital authorization artifact 120 without at least one of evaluating semantic content of the requester system 30, detecting an artificial intelligence essence of the requester system 30, and modifying an AI prompt for use in the requester system 30. Accordingly, the disclosed authorization system 2 may provide an improvement over known AI environments (not shown) in which actions may be initiated, chained, or delegated by autonomous systems, making it difficult to establish clear human authorization boundaries and attribution. Specifically, the authorization system 2 may address this gap by treating human authorization itself as a distinct, enforceable system layer that produces a portable authorization event for downstream consumption.

Furthermore, it will also be appreciated that inclusion of the AI system 38 as part of the requester system 30 may be configured for scenarios where consumption of the real-time digital authorization artifact 120 may be required not just for an invocation of the AI system 38, but for subsequent downstream AI or agentic calls that may be triggered by prior AI outputs. In other words, the real-time digital authorization artifact 120 may be enforced as a prerequisite across chained or recursive AI actions.

In such an instance, the method 400 may further include generating an AI output with the AI system 38, and consuming another real-time digital authorization artifact at the requester system 30 as a prerequisite for another invocation of the AI system 38 after generation of the AI output in order to prove that the real human being 100 was present and authorized during another set time window on the user device 50. Accordingly, a new, distinct runtime authorization artifact may be generated for each invocation of the AI system 38 such that runtime artifacts in accordance with one example embodiment of the disclosed concept may never be reused. That is, in recursive or chained AI scenarios, each authorization gate employed may require a separate live human authorization event and a newly generated artifact.

In one example, consuming the real-time digital authorization artifact 120 at the AI system 38 as a prerequisite for invocation of the AI system 38 may provide the AI system 38 with a non-language enforcement mechanism positioned prior to probabilistic model invocation, and this mechanism may be configured to permit, defer, or block invocation based on one or more of signals corresponding to presence of a valid real-time human authorization event, provenance or source-of-origin indicators, detection of recursive or chained AI-to-AI invocation, and scope or authority mismatch relative to a declared invocation context. Consuming the real-time digital authorization artifact 120 at the AI system 38 as a prerequisite for invocation of the AI system 38 may thus not be an evaluation of semantic content, a detection of an AI essence, or a modification of AI prompts, but instead may strictly be a hard pre-invocation gate enforcing invocation eligibility at the system boundary, thereby providing additional insurance and boundary ownership to the AI system 38 rather than a primary value center.

Additionally, in instances where the requester system 30 includes the chat-based system 34, one participant may request real-time authentication from another, and if the recipient is enrolled and consents, the authorization system 2 may generate the real-time digital authorization artifact 120 in order to confirm live human presence and optional identity attributes. If not enrolled or declined, authentication may be unavailable.

Regarding the optional identity attributes, and with reference again to FIG. 2B, the authorization system 2 may optionally disclose a limited identity attribute 48 (e.g., without limitation, name, sex, age) of the real human being 100 only under a standing user consent. As shown in the flow chart 300, the real human being 100 may or may not provide a revocable consent 102 to the cryptographic module 10 before the real-time digital authorization artifact 120 is generated. The revocable consent 102 may be granted once and be revocable, such that revocation may disable attribute disclosure and may also disable participation in systems configured as membership-gated. The method 400 of FIG. 3 may thus further include disclosing the identity attribute 48 (e.g., without limitation, name, age, sex) of the real human being 100 after consuming the real-time digital authorization artifact 120 responsive to the revocable consent 102 being granted to the cryptographic module 10 by the real human being 100.

Depending on context or risk, the authorization system 2 may require any number or combination of live biometric participations (e.g., voice, facial, touch, motion). Furthermore, in terms of anti-replay and liveness, the cryptographic module 10 may include a time-bounded anti-replay mechanism 12 in order to generate the real-time digital authorization artifact 120. The time-bounded anti-replay mechanism 12 may include randomized voice challenges, short validity windows, nonce binding, replay detection, and optional multi-modal liveness checks. Furthermore, it will be appreciated that authorization validity in the authorization system 2 may be conditioned on responsiveness consistent with real-time human interaction, such that responses exhibiting latency inconsistent with physical human participation (e.g., remote synthesis, relay, or injection) may be rejected. That is, in accordance with the disclosed concept latency characteristics may serve as supporting evidence of liveness and non-mediation, alongside the existing time-bounded and anti-replay mechanisms discussed above.

The authorization system 2 may also be configured to provide for failure detection, such that the real-time digital authorization artifact 120 may not be generated if a biometric participation fails, if a confirmation of ownership of the user device 50 fails, if a time window expires, and/or if a policy constraint of the authorization system 2 is violated. It will therefore be appreciated that benefits of the authorization system 2 may lie in treating real-time human authorization as a distinct, enforceable system layer, employing live human presence verification (e.g., via a biometric participation) per authorization event, binding authorization to device context and time, emitting the real-time digital authorization artifact 120 for consumption across the requester system 30, and separating human authorization from decision-making and execution. The authorization system 2 may also be distinguishable over and provide advantages over, for example, passkeys, biometrics, and identity wallets by producing a portable, real-time human authorization event rather than merely authenticating an account or unlocking a device.

Additionally, the authorization system 2 may be guarded against authorization attempts from users other than the real human being 100 and associations other than associations with the enrolled user device 50. For example, the method 400 of FIG. 3 may further include steps of receiving an authorization attempt at the requester system 30 from a second user device, and rejecting the authorization attempt at the requester system 30 because the second user device is not associated with the real human being 100 and/or because the second user device is not the first user device 50. Put differently, the authorization system 2 may reject authorization attempts originating from non-bound or remote devices (e.g., any device other than the enrolled, device-bound user device 50 that may be attempting to originate or relay an authorization event, including proxy, mirrored, replayed, or relayed attempts). An intent in such an instance may be to distinguish mere human presence from correct human authorization. For example, even if a person is present, authorization should fail if that person is not the enrolled, device-associated real human being 100 or is attempting to satisfy the authorization on behalf of another (including under coercion).

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality can be separated or combined in blocks differently in various implementations of the disclosure or described with different terminology. These and other variations, modifications, additions, and improvements can fall within the scope of the disclosure as defined in the claims that follow.

What is claimed is:

1. A computer-implemented authorization method, comprising:
generating with a cryptographic module a real-time digital authorization artifact based on a live human authorization event;
emitting the real-time digital authorization artifact from the cryptographic module;
consuming the real-time digital authorization artifact at a requester system as a prerequisite for an action in the requester system in order to prove that a real human being was present and authorized during a set time window on a user device; and
providing the requester system as being architecturally separated from the cryptographic module.

2. The method according to claim 1, further comprising:
receiving a live human presence verification of the real human being at the user device; and
receiving an association of the real human being with the user device;
wherein the live human authorization event comprises both the live human presence verification and the association of the real human being with the user device.

3. The method according to claim 2, wherein the live human presence verification comprises a voice biometric participation of the real human being.

4. The method according to claim 3, wherein the live human presence verification comprises at least one other biometric participation of the real human being.

5. The method according to claim 2, wherein the cryptographic module is a hardware-backed key store.

6. The method according to claim 2, further comprising controlling the cryptographic module to generate and emit the real-time digital authorization artifact with the user device.

7. The method according to claim 2, wherein consuming the real-time digital authorization artifact comprises determining that the real human being was present and authorized during the set time window on the user device without at least one of an identity session being performed in the requester system, a password-based authentication being performed in the requester system, and a long-term biometric storage being employed by the requester system.

8. The method according to claim 2, wherein the user device is a first user device, and wherein the method further comprises:
receiving an authorization attempt at the requester system from a second user device; and
rejecting the authorization attempt at the requester system because at least one of the second user device is not associated with the real human being and the second user device is not the first user device.

9. The method according to claim 1, wherein providing the requester system as being architecturally separated from the cryptographic module comprises generating with the cryptographic module being separate from a decision-making function of the requester system.

10. The method according to claim 1, wherein providing the requester system as being architecturally separated from the cryptographic module comprises generating with the cryptographic module being separate from an execution function of the requester system.

11. The method according to claim 1, wherein providing the requester system as being architecturally separated from the cryptographic module comprises generating with the cryptographic module being separate from an intent interpretation function of the requester system.

12. The method according to claim 1, wherein the real-time digital authorization artifact is a cryptographically verifiable authorization artifact.

13. The method according to claim 1, further comprising employing a time-bounded anti-replay mechanism with the cryptographic module in order to generate the real-time digital authorization artifact.

14. The method according to claim 1, wherein the requester system comprises at least one of an application program interface, a chat-based system, a website, an artificial intelligence (AI) system, and a non-AI agentic control layer.

15. The method according to claim 1, further comprising receiving an authorization challenge from the requester system at the user device before generating with the cryptographic module.

16. The method according to claim 1, wherein the real-time digital authorization artifact comprises at least one of a timestamp, a validity window, a nonce number, a device binding reference, and assurance metadata.

17. The method according to claim 1, further comprising verifying at least one of a freshness of the real-time digital authorization artifact, a signature of the real-time digital authorization artifact, and a scope of the real-time digital authorization artifact with the requester system after consuming the real-time digital authorization artifact.

18. The method according to claim 1, further comprising disclosing an identity attribute of the real human being after consuming the real-time digital authorization artifact responsive to a revocable consent being granted to the cryptographic module by the real human being.

19. The method according to claim 1, wherein the requester system comprises an artificial intelligence (AI) system, and wherein the action comprises invocation of the AI system.

20. The method according to claim 19, further comprising at least one of permitting, deferring, and blocking the invocation based on a signal corresponding to a presence of the live human authorization event.

21. The method according to claim 19, further comprising at least one of permitting, deferring, and blocking the invocation based on a signal corresponding to at least one of a provenance indicator of the real-time digital authorization artifact and a source-of-origin indicator of the real-time digital authorization artifact.

22. The method according to claim 19, further comprising:
generating an AI output with the AI system; and
consuming another real-time digital authorization artifact at the requester system as a prerequisite for another invocation of the AI system after generation of the AI output in order to prove that the real human being was present and authorized during another set time window on the user device.

23. The method according to claim 19, further comprising at least one of permitting, deferring, and blocking the invocation based on a signal corresponding to at least one of a scope mismatch and an authority mismatch relative to a context of the invocation.

24. The method according to claim 19, wherein consuming the real-time digital authorization artifact is performed without at least one of evaluating semantic content of the requester system, detecting an artificial intelligence essence of the requester system, and modifying an AI prompt for use in the requester system.

25. The method according to claim 1, further comprising:
receiving at the user device a real-time, dynamically generated authorization prompt that is configured to require an immediate response from the real human being within a constrained time window; and
receiving at the user device the immediate response from the real human being within the constrained time window in response to receiving at the user device the real-time, dynamically generated authorization prompt,
wherein generating with the cryptographic module is performed in response to receiving the immediate response.

26. The method according to claim 25, further comprising initiating the prompt at the requester system.

27. The method according to claim 26, wherein the prompt is a non-reusable prompt in order to provide an enforcement mechanism for liveness and replay assistance with respect to generation of the real-the time digital authorization artifact.

28. The method according to claim 26, wherein the prompt is a modality-agnostic prompt in order to allow the immediate response to be provided from at least one of a voice biometric participation of the real human being, a facial biometric participation of the real human being, a touch biometric participation of the real human being, and a motion biometric participation of the real human being.

29. The method according to claim 26, wherein initiating the prompt and receiving at the user device the immediate response are each performed in an independently configurable manner in order to allow the real-time digital authorization artifact to be tuned via a number of parameters for at least one of a number of different risk profiles, a number of different environments, and a number of different deployment contexts.

30. The method according to claim 29, wherein initiating the prompt and receiving at the user device the immediate response are each performed without modifying a core logic of the requester system.

31. The method according to claim 1, wherein generating with the cryptographic module is performed without inference from stored enrollment data.

32. The method according to claim 1, wherein the cryptographic module has a modality selection and a strictness level, and wherein generating with the cryptographic module is performed with the modality selection and the strictness level each being policy-configurable and not architecturally fixed with respect to the cryptographic module.

33. The method according to claim 1, further comprising:
generating with the cryptographic module an enrollment artifact before generating with the cryptographic module the real-time digital authorization artifact;
providing the real-time digital authorization artifact as a runtime artifact; and
comparing with the requester system the runtime artifact to the enrollment artifact in order to prove that the real human being was present and authorized during the set time window on the user device.

34. An authorization system, comprising:
a cryptographic module configured to generate a real-time digital authorization artifact based on a live human authorization event, and emit the real-time digital authorization artifact; and
a requester system configured to consume the real-time digital authorization artifact as a prerequisite for an action in order to prove that a real human being was present and authorized during a set time window on a user device, the requester system being architecturally separated from the cryptographic module.
